(19) United States
(12) Patent Application Publication
(10) Pub. No.: US 2026/0012869 A1
(43) Pub. Date: Jan. 8, 2026

(54) INTRA-CELL HANDOVER OPTIMIZATION

(71) Applicant: APPLE INC., Cupertino, CA (US)

(72) Inventors: Fangli Xu, Beijing (CN); Ralf Rossbach, Munich (DE); Peng Cheng, Beijing (CN); Haijing Hu, Los Gatos, CA (US); Ping-Heng Kuo, London (GB); Sethuraman Gurumoorthy, San Ramon, CA (US); Naveen Kumar R. Palle Venkata, San Diego, CA (US); Alexander Sirotkin, Hod Hasharon (IL)

(21) Appl. No.: 18/881,868

(22) PCT Filed: Aug. 9, 2022
(86) PCT No.: PCT/CN2022/111177

§ 371 Date: Jan. 7, 2025

(51) Int. Cl. H04W 36/24; H04W 36/08

(52) U.S. Cl. CPC H04W 36/249; H04W 36/08

(57) ABSTRACT

The present disclosure relates to intra-cell Handover optimization. There provides a wireless device, comprising: at least one antenna; at least one radio coupled to the at least one antenna; and a processor coupled to the at least one radio; wherein the processor is configured to; acquire gap configuration information; stop communication between the wireless device and network side in a time gap indicated by the gap configuration information; and resume the communication between the wireless device and the network side after the time gap.

### TECHNICAL FIELD

This application relates generally to wireless communication, including handover in a wireless communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to improved Handover in the wireless communication systems, and particularly relate to reduce signaling overhead related to Handover in the wireless communication systems.

According to the techniques described herein, for possible Handover of wireless devices in a wireless communication system, at least one of the wireless devices can stop or suspend their operations, such as communication with the network side, in a specific time period which is, for example, originally intended to be used for the Handover, without performing Handover related signaling, and after such time period, such at least one wireless device can resume their communication with the network side. Therefore, the signaling overhead related to Handover can be reduced to some extent, and thus the system performance can be improved.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A illustrates exemplary non-terrestrial network.

FIG. 3B illustrates the difference on the RSRP change in the cell center and the cell edge between TN network and NTN network.

FIG. 3C illustrates transitions of UEs as a cell moves completely out of original coverage area.

FIG. 4A is a flowchart diagram illustrating an exemplary intra-cell HO process according to some embodiments of the present disclosure, and FIG. 4B illustrates exemplary signaling in the intra-cell HO process according to some embodiments of the present disclosure.

FIG. 5 is a flowchart diagram illustrating an example method at the wireless device side according to some embodiments of the present disclosure.

FIG. 6 is a flowchart diagram illustrating an example method at the network device side according to some embodiments of the present disclosure.

FIGS. 7A and 7B illustrate exemplary gap configuration according to some embodiments of the present disclosure.

FIGS. 8A to 8C illustrates exemplary access control according to some embodiments of the present disclosure.

### DETAILED DESCRIPTION

### Terms

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system. As an example, the base station may be, for example, an eNB in a 4G communication standard, a gNB in a 5G communication standard, a remote radio head, a wireless access point, an unmanned aerial vehicle control tower, or a communication device that performs similar functions.

Network Device—any of various types of computer systems or devices that perform communications, particularly perform wireless communication with the wireless device, such as downlink communication to the wireless device related to downlink transmission. The network device can be portable (or mobile) or may be stationary or fixed at a certain location. A base station is an example of a network device.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

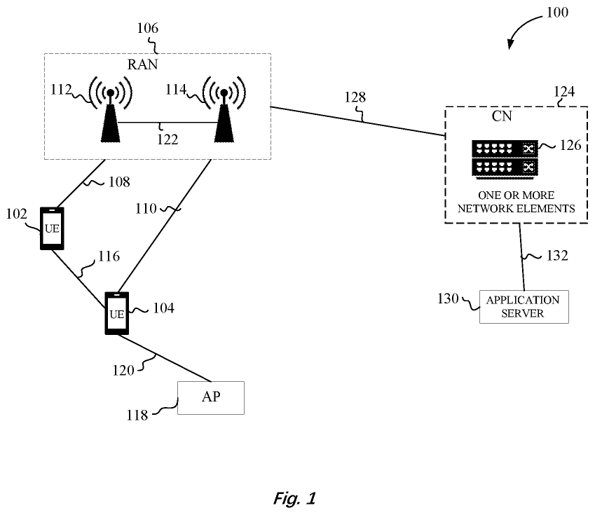

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

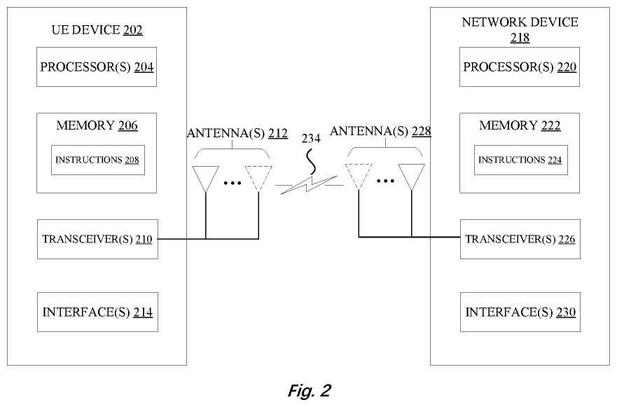

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may be used for various aspects of the present disclosure, particularly configure appropriate delay time for Handover operation and/or performing the Handover operation when the delay time expires. Such operation/functionality can be implemented via hardware, software, or combinations thereof. For example, such operation/functionality can be performed by means of a specific component incorporated in the wireless device, for example, a processor, circuit, which can be integrated within the processor(s) 204 and/or the transceiver(s) 210, and/or can be performed by means of software, such as instructions 208 stored in the memory 206 and executed by the processor(s) 204. In particular, such functionality can be implemented by a combination of software components (e.g., executed by a DSP or a general processor) and hardware components (e.g., logic gates and circuitry) within the processor(s) 204 or the transceiver(s) 210. Some embodiments of such operation/functionality will be described below in detail with reference to figures.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may be used for various aspects of the present disclosure, particularly configure appropriate delay time for Handover operation and/or provides the configured delay time to the wireless devices so that the wireless device can perform the Handover operation when the delay time expires. Such operation/functionality can be implemented via hardware, software, or combinations thereof. For example, such operation/functionality can be performed by means a specific component incorporated in the wireless device, for example, a processor, circuit, which can be integrated within the processor(s) 220 and/or the transceiver(s) 226, and/or can be performed by means of software, such as instructions 224 stored in the memory 222 and executed by the processor(s) 220. In particular, such functionality can be implemented by a combination of software components (e.g., executed by a DSP or a general processor) and hardware components (e.g., logic gates and circuitry) within the processor(s) 220 or the transceiver(s) 226. Some embodiments of such operation/functionality will be described below in detail with reference to figures.

Wireless communication techniques are continually under development, to increase coverage, to better serve the range of demands and use cases, and for a variety of other reasons.

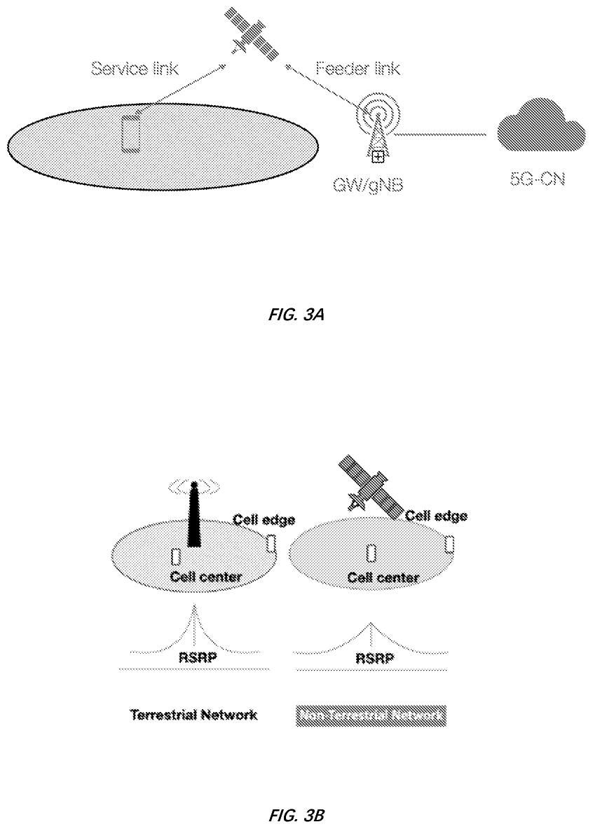

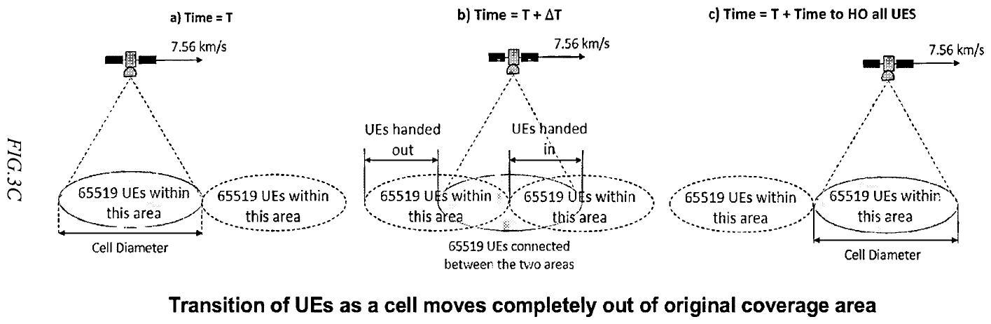

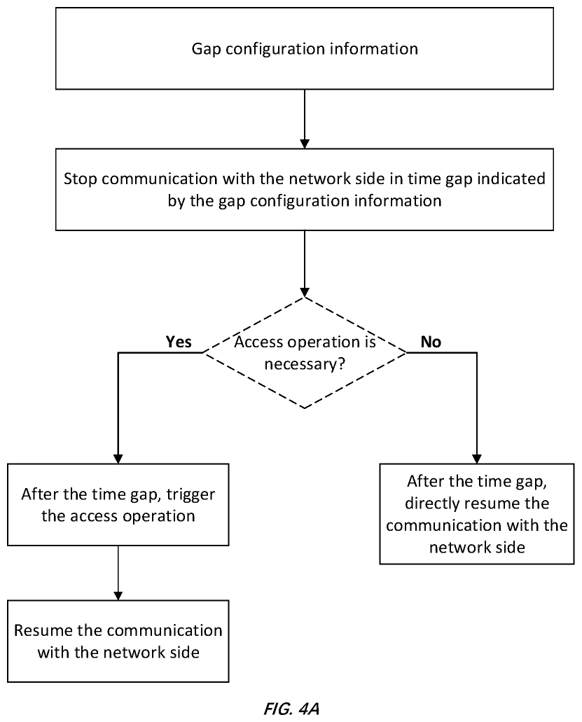

In wireless communication cases, there usually exist a variety of network architectures, particularly Non-Terrestrial Networks (NTN) which may include ground part and the air/space part. Herein, the ground part usually refers to networks or segments of networks which can use any ground equipment for communication, the air/space part usually refers to networks, or segments of networks which can use an airborne or spaceborne vehicle for communication transmission, and may be so-called space-based networks, where spaceborne vehicles can be a variety of appropriate kinds of spacecrafts or aircrafts running in space according to the laws of celestial mechanics, such as any appropriate kind of satellite, including, but not limited to Low Earth Orbit (LEO), Medium Earth Orbit (MEO), Geosynchronous Earth Orbit (GEO), High Earth Orbit (HEO) satellites, and so on. Airborne vehicles can include a variety of appropriate vehicles at appropriate space height, such as High Altitude Platforms (HAPS), and so on. FIG. 3A illustrates an exemplary NTN network architecture including two parts: a ground part, which includes a gNB and/or GW part to process the data in RAN side, and a satellite, or other airborne, space borne in the air/space, which is transparently forwarding the data between the UE and the gNB, such as by means of a service link and a feeder link.

For Non-Terrestrial Networks, there may exist many usage scenarios in which the Non-Terrestrial Networks can address mobile broadband needs and public safety needs in unserved/underserved areas, and such usage scenarios may include, but not limited to, Maritime, airplane connectivity, railway, and so on.

For Non-Terrestrial Networks, there may usually exist many assumptions. More specifically, it is usually assumed that a NR NTN, especially LEO and GEO, has implicit compatibility to support HAPS and ATG (Air-To-Ground) scenarios. In particular, the NTN may focus on Frequency Division Duplex (FDD), while Time Division Duplex (TDD) may be applied for relevant scenarios e.g., HAPS, ATG, and the NTN may cover or have Earth fixed tracking area, In the NTN, the wireless devices, such as UEs, can have GNSS capabilities, have transparent payload. Furthermore, the NTN can support or cover any appropriate devices, such as Handheld devices in FR1 (e.g., power class 3), “VSAT” devices with external antenna at least in FR2 (RAN1-3 specifications), and so on.

In wireless communication via NTNs, an NTN cell will cover a wider radio cells, where the NTN cell may mean a cell covered or served by a spacecraft or aircraft, such as a satellite. More specifically, in NTN, the coverage of a cell or a beam for the cell is typically much larger than the cell in the terrestrial networks, and the coverage of one NTN cell may even across multiple countries.

A Handover (also be referred to as HO) belongs to a kind of operation frequently occurring in the wireless communication that when a cell in which a user terminal is located or a network device serving the user terminal is intended to change, the user terminal would disconnect with the previous network device (referred to as a source network device) and then connect to a new network device (referred to as a target network device). Such Handover operation can be performed in a variety of manners. In an example, the user terminal moves from a cell (referred to as source cell) to a new cell (referred to as a target cell), and to continue to perform wireless communication, the user terminal needs to disconnect with the source cell or related network device and then switch to the target cell to connect with the target network device. In another example, the network device may have a coverage including a huge amount of wireless devices, such as in a NTN, and the network device, such as a satellite, may move so that even the user terminal does not move, the network device serving the user terminal may change, which also means the cell serving the user terminal changes, and thus when a new network device move to cover the wireless devices, the wireless device will perform the Handover operation to disconnect with the previous network device and then connect to the new wireless device.

In the wireless communication system, Handover can be implemented in any appropriate handover frames, such as an appropriate Legacy handover mechanism, in which the user terminal will perform the Handover upon receipt of Handover common from the network device. Such Legacy handover mechanism will be supported with some restrictions. For example, UE is not required to connect to both an NTN and TN cell simultaneously during handovers, and/or DAPS (Dual Active Protocol Stack) is not supported.

Furthermore, Handover can be implemented in Conditional Handover (also be referred to as CHO) mechanism, in which the user terminal can perform the Handover when the user terminal judges the Handover condition is met based on a measurement result. In particular, conditional Handover conditions are introduced for NTN specific CHO due to the NTN radio characteristics. More specifically, NTN specific characteristics may include that the variation in signal strength/quality between cell-center and cell-edge is not so pronounced, as shown in FIG. 3B. NTN specific CHO conditions may include any appropriate condition, such as condEventA4, condEventT1, condEventD1, etc., as shown in the following Table 1. Wherein EventD1 can be configured as the normal measurement event for measurement report. Note that condEventT1 and condEventD1 is always configured together with one of the measurement-based trigger conditions (CHO events A3/A4/A5).

TABLE 1

| NTN CHO | |
|---|---|
| condition | Description |
| condEventA4 | Measurement event A4 (i.e. Neighbour becomes better than threshold) |
| condEventT1 | Time-based trigger condition |
| | CHO can be executed only between T1 and T2 |
| | NW configures T1 (i.e. t1-Threshold) and duration (duration) using UTC time |
| condEventD1 | Location-based trigger condition |
| | CHO can be executed when the following two conditions are fulfilled |
| | Distance between UE and a referenceLocation1 > distanceThreshFromReference1; |
| | (away from PCell) |
| | Distance between UE and a referenceLocation2 < distanceThreshFromReference2; |
| | (close to candidate cell) |

CHO recovery can be executed in a variety of manners. More specifically, for the candidate cell with condEventT1, CHO recovery cannot be executed if timer T2 has not expired, and for the candidate cell with condEventD1, CHO recovery can be excluded without checking condEventD1.

The NTN specific scenario may include a variety of scenarios. In particular, in a LEO scenario, the cell is moving together with the satellite, and all the UEs in the geographic area have to perform the handover due to the satellite change. In a feeder link switching case, the cell served by the satellite will change, and all the UEs served by the satellite have to perform the handover due to the cell information change, even though the service link is no change. For example, FIG. 3C illustrates exemplary transitions of UEs as a cell moves completely out of original coverage area.

However, the NTN specific handover may have issues. More specifically, considering the large cell size of non-terrestrial networks, huge amounts of devices may be served within a single cell. Depending on constellation assumptions (e.g., propagation delay and satellite speed) and UE density, a potentially very large number of UEs may need to perform HO at a given time, leading to possibly large signaling overhead and service continuity challenges. In particular, the signaling overhead due to the UE handover, particularly group UE handover, shall be avoided.

Therefore, it is still desirable to improve Handover operation, particularly reduce Handover signaling overhead.

In view of this, the present disclosure proposes a novel solution that at least one of UEs in a source cell can stop or suspend communication between the at least one UE and the network side in a specific time period which is, for example, originally intended to be used for the Handover, instead of executing Handover signaling as usual, and then resume the communication between the UE and the network side after such specific time period. Note that such a solution can be particularly applied to scenarios where the network device may change, but the communication configuration for the wireless device may not change or there may not exist Handover change, and in such scenarios, the wireless device can operate just like they are always located within the source cell, irrespective of network device change, and thus the process according to the present disclosure may be referred to as or equivalent to an intra-cell HO process. Such scenarios may particularly relate to NTN scenarios, wherein the serving satellite changes but no configuration or HO change.

Compared with the case in the prior art that a plurality of UEs need to perform HO at a given time conventionally, in the present disclosure, at least one UE can stop or suspend its communication with the network side in a time period where the network device is intended to change, instead of executing the HO signaling, and after such time period, that is, when the network device change is almost done, the at least one UE would resume the communication. Therefore, the HO operations to be executed by at least one UE, such as HO signaling, can be omitted to some extent, and the signaling overhead can be reduced.

Various embodiments according to the present disclosure will be described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component of the wireless device, or the wireless device. Additionally, various embodiments according to the present disclosure will be described with regard to a gNB. However, reference to a gNB is merely provided for illustrative purposes. The example embodiments may be utilized with any electronic component that may establish a connection to a wireless device and is configured with the hardware, software, and/or firmware to exchange information and data with the wireless device. Therefore, the gNB as described herein is used to represent any appropriate electronic component of the network device, or the network device.

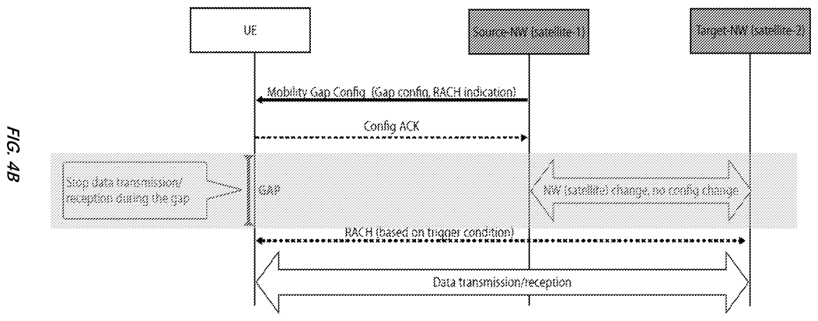

FIGS. 4A and 4B illustrate conceptual diagrams of so-called intra-cell process according to some embodiments of the present disclosure.

In particular, the wireless device may acquire a gap configuration information which may indicate the time gap wherein the communication between the wireless device and the network side is intended to stop or suspend. Specifically, such time gap may relate to the conventional Handover time period during which the network device changes, such as satellite change in the NTN. And then during such time gap, the communication between the wireless device and the network side, for example, data communication including data transmission and/or reception, can be stopped/suspended. Note that the communication between the wireless device and the network side may mean the communication between the wireless device and the source network device, that is, the old or current network device serving the wireless device in the source cell.

Then, after the time gap, the communication between the wireless device and the network side can be resumed. Considering that during such time gap, the network device may be changed, such as from the source network device to a target network device, the resumed communication between the wireless device and the network side may mean the communication between the wireless device and the target network device.

In one implementation, such communication can be directly resumed by the wireless device after the time gap, such as in accordance with the previous configuration which may not change during such change of network device. In another implementation, the wireless device can perform any appropriate access operation to access to the target network device, and then resume the communication between the wireless device and the target network device. Such access operation can be implemented in a variety of manners, such as Random Access Channel (RACH), contention-based Random Access (CBRA), contention-free Random Access (CFRA) etc. Furthermore, the access operation can be performed upon command or indication from the network devices, particularly the source network device, and in such a case, the command or indication can be provided along with or separately from the gap configuration information. Alternatively, whether the access operation shall perform can be determined by the wireless device itself, which will be described hereinafter.

Note that the above so-called intra-cell HO process according to the present disclosure is only exemplary, and it can be implemented in any other appropriate manner. In particular, such access operation is optional, and may not be performed.

Hereinafter, the solution of the present disclosure will be described by taking NTN HO scenario as an example. Note that the solution of the present disclosure can be applied to any appropriate HO scenarios, including but not limited to NTN-to-NTN HO scenarios, NTN to TN HO scenarios, TN to NTN HO scenarios, TN to TN HO scenarios, etc., particularly such scenarios that the serving devices change but there exists no configuration and/or HO change, and similar improvement can be achieved.

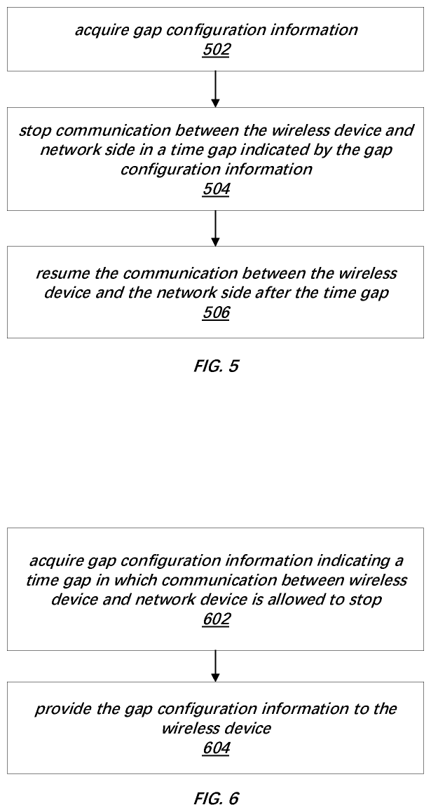

FIG. 5 illustrates a flowchart illustrating an example method at the wireless device side at least according to some embodiments. Aspects of the method of FIG. 5 may be implemented by a wireless device such as a UE 106 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 5 may operate as follows.
At step 502, the wireless device acquires a gap configuration information, which, for example, may indicate a time gap during which the communication can be stopped/suspended, and which may correspond to or relate to a time period during which network device change may be almost done and a Handover may be originally intended to be executed conventionally in the prior art.
At step 504, the wireless device stops or suspends the communication in the time gap. In particular, when the wireless device acquires the gap configuration information, the wireless device will stop or suspend the communication in the time gap as indicated by the gap configuration information. Note that such communication between the wireless device and the network side may mean or include the communication between the wireless device and the source network device, for example any data communication including data transmission and/or receipt.
At step 506, the wireless device resumes the communication between the wireless device and the network side after the time gap. Note that such communication between the wireless device and the network side may mean or include the communication between the wireless device and the target network device.

Thus, the method of FIG. 5 may be used by a wireless device to perform improved Handover, at least according to some embodiments.

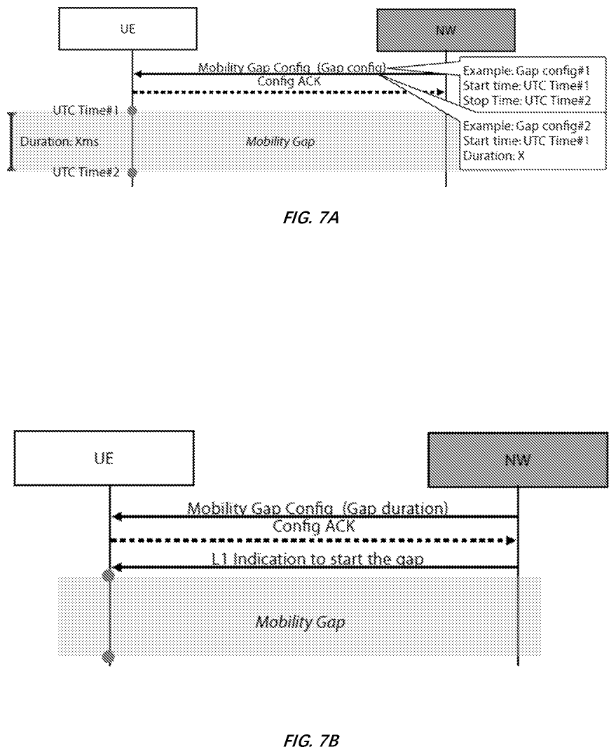

FIG. 6 illustrates a flowchart illustrating an example method at the network device side at least according to some embodiments. Aspects of the method of FIG. 6 may be implemented by a network-side device for example a base station such as a BS 102 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 6 may operate as follows.
At step 602, the network device acquires gap configuration information, which, for example, may indicate a time gap during which the communication can be stopped/suspended, and which may correspond to or relate to a time period during which network device change may be almost done and a Handover may be originally intended to be executed conventionally in the prior art.
At step 604, the network-side device may provide the gap configuration information to the wireless device, so that the wireless device can stop or suspend the communication between the wireless device and the network side in the time gap indicated by the gap configuration information.

Thus, the method of FIG. 6 may be used by a network-side device, such as a base station, to schedule an improved Handover operation, at least according to some embodiments.

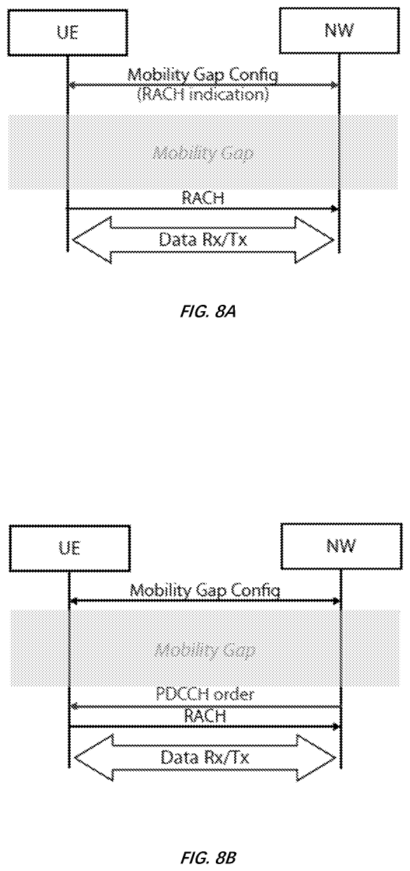

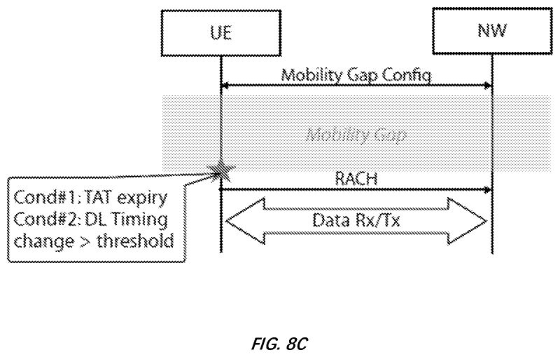

FIGS. 7A-8C illustrate further aspects that might be used in conjunction with the method of FIGS. 5 and 6 if desired. It should be noted, however, that the exemplary details illustrated in and described with respect to FIGS. 7A-8C are not intended to limit the disclosure as a whole, and numerous variations and alternatives to the details provided herein below are possible and should be considered within the scope of the disclosure.

According to some embodiments, the time gap indicated or included in the gap configuration information may be determined in a variety of manners.

In one embodiment, the time gap can be determined or configured based on the network device change situation. For example, in the case of NTN scenario, the time gap can be determined based on the satellite change situation, particularly, the change from an old or source satellite to a new or target satellite, such as the duration of such change. For example, the time gap may be determined or configured so as to or correspond to a time period during which such change is almost done, particularly completion of a source network device changing to a target network device in the network side.

In some embodiments, the gap configuration information can be represented in a variety of manners. In an example, the gap configuration information may include the start time and end time of the time gap. In another example, the gap configuration information may include the start time and duration of the time gap, or the end time and duration of the time gap. In yet another example, the gap configuration information may include an index indicating the time gap, such as index indicating the start time and/or end time and/or duration of the time gap.

In some embodiments, the start time and/or end time of the time gap is represented by absolute time or relative time. For example, the absolute time may be UTC time, and in another example, the relative time may mean the time relative to a reference time, such as the time when the change of network device starts, the time when the condition of network device change is met, and so on. And the relative time may correspond to time difference, and can be indicated or presented in units of frame, subframes, SFN, symbols, slots, etc.

According to some embodiments of the present disclosure, the gap configuration information can be determined or configured by any appropriate device and provided to the wireless device. In one embodiment, the gap configuration information can be determined by the network device, such as the source network device, the target network device, or any other appropriate device in the wireless communication system. In an example, the gap configuration information can be determined by the target network device, then provided to the source network device and in turn provided to the wireless device.

According to some embodiments of the present disclosure, the gap configuration information can be provided to the wireless devices in the system in a variety of manners. In one embodiment, the gap configuration information can be provided to the wireless devices via common signaling, for example, the gap configuration information can be provided to at least one wireless devices in the source cell, such as at least one group of wireless devices, all wireless devices, etc., via broadcasting, system information block (also be referred to as SIB), paging, common or group L1, L2 or L3 signaling, and so on. In another embodiment, the gap configuration information can be provided to respective wireless devices via wireless device dedicated signaling. That is, the gap configuration information can be determined or configured for specific or desired wireless devices and provided to the wireless devices via the wireless device dedicated signaling. For example, the gap configuration information can be provided via L1, L2 or L3 signaling dedicated to wireless devices.

According to some embodiments of the present disclosure, the at least one wireless device or at least one group of wireless devices, for which the time gap is configured, or the number of wireless devices or number of wireless device group, can be determined appropriately. In an example, the number of the at least one wireless device can be determined randomly. For example, the network device can select the UEs in the cell which can be configured with the gap configuration information randomly, such as via a random function, for example, random number of UEs, random group of UEs, or even all UEs, and then the gap configuration information can be provided to the selected UEs, such as via dedicated signaling or common signaling. In some embodiments of the present disclosure, the time gap indicated in the gap configuration information can be equally configured or determined for the wireless devices. That is, the same time gap may be applied to the at least one wireless device.

According to some embodiments, the wireless device can feedback acknowledge information to the network side in response to receipt of the gap configuration information. For example, FIG. 7A illustrates feedback of such acknowledge information, wherein the acknowledge is feedback in response to receipt of the gap configuration information, and the wireless device will stop or suspend the communication in the time gap.

Note that the above feedback is optionally, and whether such feedback is provided can be configured in any appropriate manner. In an example, which such feedback is provided can be preconfigured, such as at initialization of the system, or configured to be provide or not provide by fault. In another example, which such feedback is provided can be configured by the network device and notified to the wireless device when providing the gap configuration information. For example, an indication information indicating whether the feedback is necessary can be provided along with the gap configuration information, and the wireless device will feedback or not feedback according to the indication information.

In some embodiments, when the feedback is necessary, the gap configuration information can be provided to the wireless device separately, for example, can be provide in two steps or stages. On the contrary, when the feedback is not necessary to provide, the gap configuration information can be provided as a whole.

In some embodiments, the separate providing the gap configuration information can be executed in a variety of manners. In an example, an information indicating that the communication between the wireless device and the network side shall be stopped/suspended in the time gap can be provided to UE, and when feedback is received from the UE successfully, then the gap configuration information, particularly the time gap, will be provided to the UE. In another example, the gap duration can be provided to the UE firstly, and when the feedback is received from the UE successfully, other details related to the time gap, particularly the start time and/or end time, will be provided to the UE.

In some embodiments, the former step or stage of providing the gap configuration information can be performed via a kind of signaling different from that in the latter step or stage. For example, the former step can be performed in the common signaling, and the latter step can be performed in the dedicated signaling, particularly with respect to the UEs which provides feedback successfully. And such operation can also be deemed as a kind of selection or configuration of UEs which may be configured with the gap configuration information so that its communication will stop or suspend in the time gap.

According to some embodiments, the process of stopping or suspending communication can be performed in a variety of manners. In an example, the process can be performed automatically, particularly in the time gap. In another example, the process can be triggered. More specifically, the wireless device may acquire trigger information, and then start to stop or suspend the communication in the time gap upon receipt of the trigger information.

The trigger information can be any appropriate information. In an example, the trigger information can be any appropriate bit, symbol, and when such information is received, the process of stopping or suspending communication is triggered, which can start immediately, or perform as indicated by the time gap.

Note that such trigger can be combined with the feedback operation. According to some embodiments, the trigger information is provided by the network side after the acknowledge information is feedback to the network side successfully. For example, as shown in FIG. 7B, the duration of time gap is first provided to the UEs, such as RRC configuration and when feedback is received from the UEs successfully, the trigger information can be provided to the UEs, such as via L1 or L2 commands, and the UEs, upon receipt of the trigger information, would start to stop or suspend the communication, for example, stop or suspend the communication immediately, or stop or suspend the communication in the time gap.

According to some embodiments of the present disclosure, after the time gap, the wireless device can resume the communication, particularly data transmission/reception, and considering the network device changes, the communication, particularly data transmission/reception, may actually mean data transmission/reception to the target network device, and the information related to the target network device may be provided by the source network device or any other appropriate device in the system. More specifically, considering the even the network device changes, there may exist no configuration change or HO change for the wireless device, therefore, from the viewpoint of the wireless device, the network device change is not known to the wireless device, and thus the wireless device can resume the communication in accordance with the configuration, just like no cell change and the communication is always executed inside the source cell, and thus such operation can be referred to as an intra-cell Handover.

According to some embodiments, resuming the communication can be performed in a variety of manners.

In one embodiment, the communication can be resumed immediately after the gap. In particular, each wireless device would resume its communication with the network side, particularly with the target network device, in accordance with the unchanged configuration.

In another embodiment, after the gap, an access operation can be first executed and then the communication can be resumed. In particular, considering that after stopping or suspending the communication between the wireless device and the network side, the communication status of the wireless device and the network side, particularly the synchronization status, may change and may even influence resumption of the communication adversely, it may be necessary to perform the access operation, particularly make the wireless device access to the network side, that is, the target network device, and such access operation may be also referred to as a re-access operation. Execution of such access can further ensure the wireless device to connect to the network side and thus improve reliability of the communication recovery to some extent.

According to some embodiments of the present disclosure, the processor is further configured to: acquire access indication information about access to the network side, and when the access indication information indicates such access is necessary, perform the access to the network side after the time gap. Specifically, the access indication information may indicate whether an access to the network side is necessary to be executed firstly.

In some embodiments, such access operation can include any kinds of appropriate access operation, such as such as Random Access Channel (RACH), contention-Based Random Access (CBRA), contention free Random Access (CFRA) etc.

According to some embodiments of the present disclosure, the access indication information can be configured or set in a variety of manners, such as implicitly or explicitly.

In some embodiments, such access indication information can be in any appropriate format. For example, the information may be a binary value, wherein “1” may indicate the access operation shall be performed, so that after the time gap, the access operation will be executed firstly and then the recovery or resumption of communication will be executed, while “0” may indicate the access operation is not necessary, so that the recovery or resumption of communication will be executed immediately after the time gap. Note that the information can be any other appropriate format, such as value, number, symbol, etc., as long as different value can be utilized to indicate whether the access operation is to be allowed.

In some embodiments, the access indication information can be configured or set for all UEs by default, such as during initialization. For example, it may be configured that all UEs would perform the access operation after the time gap. In another example, when there is no such access indication information, it may mean that all UEs would perform the access operation after the time gap.

In some embodiments, such access indication information can be provided to the wireless device and received by the wireless device. For example, such access indication information can be received from the network side, that is, such access indication information can be configured or set by the network side and in turn provided to the wireless device. Note that the access indication information can be generated by the source network device and then provided to the wireless device, or can be generated by the target network device, and then presented to the source network device so as to provide to the wireless device, or can be generated by any other appropriate device in the system and then provided to the wireless device.

According to some embodiments of the present disclosure, the access indication information can be provided to the wireless device in a variety of manners.

In some embodiments, the access indication information can be provided to the wireless device via a common signaling, such as broadcasting, paging, common L1, L2, L3 signaling, etc. For example, when such access indication information is configured for all UEs, such access indication information will be provided to UEs via common signaling. In another example, when such access indication information is configured for specific groups of UEs, such access indication information will be provided to UEs via common signaling for each group of UEs.

In some embodiments, the access indication information can be provided to the wireless device via dedicated signaling, such as UE dedicated L1, L2, L3 signaling. For example, when the access indication information is configured or set for respective UEs, such access indication information can be provided to respective UEs via UE dedicated signaling.

According to some embodiments, the access indication information can be provided to the wireless devices at any appropriate time. In some embodiments, the access indication information can be provided to the wireless devices before the time gap, such as can be provided to the wireless device along with the gap configuration information, as shown in FIG. 8A.

In some embodiments, the access indication information can be provided to the wireless device after the time gap. For example, after the time gap, the network device can provide the access indication information to at least one UEs in the cell, as shown in FIG. 8B.

According to some embodiments, the access indication information can be configured or determined based on the UE's communication status, particularly UE's synchronization status or communication status change condition. That is, the access indication information can be configured or determined with respect to respective UE, based on respective UE's communication status, particularly, UE's synchronization status or communication status change condition.

In some embodiments, the UE's communication status may include, but not limited to, at least one of UL synchronization or timing status, DL timing change condition or DL synchronization status.

In some embodiments, the UL timing status may relate to UL synchronization. When the UL timing status indicates the UE is out of UL synchronization, the access indication information will be configured so that the UE shall perform access operation. For example, the UL timing status can be monitored, such as by means of a timer, for example, TA timer, and when the TA timer expires, which means the UE is out of UL synchronization, the UE will perform access operation.

In some embodiments, the DL timing change condition may relate to the influence on data reception from the network device or DL synchronization, and when the DL timing change condition is so large that the data reception from the network device or DL synchronization may be influenced adversely, the access indication information will be configured so that the UE shall perform access operation. for example, when the DL timing change condition is larger than or equal to a threshold, the UE will preform the access operation.

In some embodiments, acquiring the access indication information based on the UE's communication status is performed by the wireless device. In particular, the wireless device can acquire the communication status after the time gap and then judge whether the access operation is necessary based on the communication status, for example, at least one of cond#1: TAT expires, and cond#2: DL timing change>threshold. When it is judged that the access operation is necessary, the wireless device would perform the access operation, such as RACH, after the time gap, as shown in FIG. 8C. Note that the above two conditions are only exemplary, and more conditions are possible. In an example, the access operation would be performed as long as any one of the conditions is satisfied. And information about the communication status, such as TA timer value, DL timing change condition, the value used for judging, such as the threshold, can be acquired, such as by being provided by the network device or other appropriate device in the system, via appropriate signaling.

In some other embodiments, whether the access operation is necessary can be judged by the network device or any other appropriate device in the system, and then the judgement result can be provided to the respective UEs as the access indication information in a variety of manners, such as before or after the gap, via dedicated signaling, etc., as discussed above, which will not described here.

According to some embodiments, the configuration of access indication information by the network device or by default can be combined with the judgment based on the UE's communication status. In particular, the access indication information can be configured or set so that the access operation is enabled for all UEs, but whether such access operation is necessary to actually execute shall be further judged based on the UE's communication status.

For example, the access indication information may include an enabling information which indicates whether the access operation of each wireless device is enabled or not, such as, “1” may indicate enabled, “0” may indicate disabled, and of course, other kinds of value, symbol, character can be utilized as the enabling information. And when the enabling information indicates the access operation is enabled, the wireless device's communication status after the time gap can be acquired and utilized to judge whether the access portion is necessary to execute, as discussed above. Note that such enabling information may be omitted, and in such a case, the access operation may be enabled for all wireless devices in the system by default.

Note that such access indication information and/or the determination of whether it is necessary to execute the access operation are optional. In an example, whether it is necessary to execute the access operation can be preconfigured in advance or by default, so that such access operation can execute or not execute in accordance with the setting. For example, such access operation would execute for each UE after the time gap automatically, without needing any further determination. As another example, such access operation would not execute for each UE after the time gap, without needing any further determination.

Embodiments contemplated herein include an apparatus comprising means to perform one or more elements of the method for intra-cell Handover at the wireless device side. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method at the wireless device side according to some embodiments of the present disclosure. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method at the wireless device side according to some embodiments of the present disclosure. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method at the wireless device side according to some embodiments of the present disclosure. This apparatus may be, for example, an apparatus of a UE (such as a wireless device 202 that is a UE, as described herein).

Embodiments contemplated herein include a signal as described in or related to one or more elements of the method at the wireless device side according to some embodiments of the present disclosure.

Embodiments contemplated herein include a computer program or computer program product comprising instructions, wherein execution of the program by a processor is to cause the processor to carry out one or more elements of the method at the wireless device side according to some embodiments of the present disclosure. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method at the network device according to embodiments of the present disclosure. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method at the network device according to embodiments of the present disclosure. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method at the network device according to embodiments of the present disclosure. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method at the network device according to embodiments of the present disclosure. This apparatus may be, for example, an apparatus of a base station (such as a network device 218 that is a base station, as described herein).

Embodiments contemplated herein include a signal as described in or related to one or more elements of the method at the network device according to embodiments of the present disclosure.

Embodiments contemplated herein include a computer program or computer program product comprising instructions, wherein execution of the program by a processing element is to cause the processing element to carry out one or more elements of the method at the network device according to embodiments of the present disclosure. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

In the following further exemplary embodiments are provided.

One set of embodiments may include A wireless device, comprising: at least one antenna; at least one radio coupled to the at least one antenna; and a processor coupled to the at least one radio; wherein the processor is configured to: acquire gap configuration information; stop or suspend communication between the wireless device and network side in a time gap indicated by the gap configuration information; and resume the communication between the wireless device and the network side after the time gap.

According to some embodiments, the gap configuration information includes the start time and end time of the time gap, or the start time and duration of the time gap.

According to some embodiments, the start time and/or end time of the time gap is represented by absolute time or relative time.

According to some embodiments, the time gap indicated in the gap configuration information depends on network device change situation.

According to some embodiments, the time gap indicated in the gap configuration information corresponds to a time period in which a source network device changes to a target network device in the network side.

According to some embodiments, the gap configuration information is received from the network side via a common signaling or a wireless device dedicated signaling.

According to some embodiments, the processor is further configured to feedback acknowledge information to the network side in response to receipt of the gap configuration information.

According to some embodiments, the processor is further configured to: acquire trigger information, and start to stop or suspend the communication in the time gap upon receipt of the trigger information.

According to some embodiments, the trigger information is provided by the network side after an acknowledge information is feedback from the wireless device to the network side successfully.

According to some embodiments, the processor is further configured to: acquire access indication information about access to the network side, and when the access indication information indicates such access is necessary, perform an access operation to the network side after the time gap.

According to some embodiments, the access indication information is received from the network side before or after the time gap.

According to some embodiments, the access indication information is provided by the network side along with the gap configuration information.

According to some embodiments, the processor is further configured to: determine, based on information about communication status between the wireless device and the network side after the gap, whether the access to the network side is necessary.

According to some embodiments, the information about communication status includes at least one of Downlink timing change condition or Uplink synchronization status.

According to some embodiments, when the Uplink synchronization status indicates the wireless device is out of Uplink synchronization, the access to the network side is necessary, and/or wherein when the Downlink timing change is larger than or equal to a threshold, the access to the network side is necessary.

Another set of embodiments may include a network device, comprising: at least one antenna; at least one radio coupled to the at least one antenna; and a processor coupled to the at least one radio; wherein the processor is configured to: acquire gap configuration information indicating a time gap in which communication between the wireless device and the network device is allowed to stop or suspend; and provide the gap configuration information to the wireless device.

According to some embodiments, the processor is further configured to acquire the gap configuration information by determining the time gap based on change situation of the network device.

According to some embodiments, the processor is further configured to: acquire acknowledgement information from the wireless device in response to the gap configuration information, and provide trigger information to the wireless device, so that the wireless device starts to stop or suspend the communication upon receipt of such trigger information.

According to some embodiments, the processor is further configured to: provide, to the wireless device, an access indication information which indicates whether an access operation to a new network device shall be performed by the wireless device after the gap.

According to some embodiments, the access indication information is provided along with the gap configuration information before the gap or after the gap.

Yet another set of embodiments may include an apparatus, comprising: a processor configured to cause a wireless device to: acquire gap configuration information; stop or suspend communication between the wireless device and network side in a time gap indicated by the gap configuration information; and resume the communication between the wireless device and the network side after the time gap.

Yet another set of embodiments may include an apparatus, comprising: a processor configured to cause a network device to acquire gap configuration information indicating a time gap in which communication between the wireless device and the network device is allowed to stop or suspend; and provide the gap configuration information to the wireless device.

Yet another set of embodiments may include a method for a wireless device, comprising: acquiring gap configuration information; stopping or suspending communication between the wireless device and network side in a time gap indicated by the gap configuration information; and resuming the communication between the wireless device and the network side after the time gap.

Yet another set of embodiments may include a method for a network device, comprising: acquiring gap configuration information indicating a time gap in which communication between the wireless device and the network device is allowed to stop or suspend; and providing the gap configuration information to the wireless device.

Yet another set of embodiments may include a device comprising: a processor, and a computer-readable storage medium, having program instructions stored thereon, which, when executed, cause the processor to implement any or all parts of any of the preceding method embodiments.

Yet another set of embodiments may include a computer-readable storage medium, having program instructions stored thereon, which, when executed, cause the processor to perform any or all parts of any of the preceding method embodiments.

Yet another set of embodiments may include a computer program product comprising program instructions, which, when executed by a computer, cause a computer to perform any or all parts of any of the preceding method embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device, comprising:
at least one antenna;
at least one radio coupled to the at least one antenna; and
a processor coupled to the at least one radio;
wherein the processor is configured to;
acquire gap configuration information;
stop communication between the wireless device and network side in a time gap indicated by the gap configuration information; and
resume the communication between the wireless device and the network side after the time gap.

2. The wireless device of claim 1, wherein the gap configuration information includes a start time and an end time of the time gap, or the start time and a duration of the time gap.

3. The wireless device of claim 1, wherein the time gap indicated in the gap configuration information depends on network device change situation.

4. The wireless device of claim 1, wherein the gap configuration information is received from the network side via a common signaling or a wireless device dedicated signaling.

5. The wireless device of claim 1, wherein the processor is further configured to:
feedback acknowledge information to the network side in response to receipt of the gap configuration information.

6. The wireless device of claim 1, wherein the processor is further configured to:
acquire trigger information, and
start to stop the communication in the time gap upon receipt of the trigger information.

7. The wireless device of claim 1, wherein the processor is further configured to:
acquire access indication information about access to the network side, and
when the access indication information indicates such access is necessary, perform an access operation to the network side after the time gap.

8. The wireless device of claim 7, wherein the access indication information is received from the network side before or after the time gap.

9. The wireless device of claim 1, wherein the processor is further configured to:
determine, based on information about communication status between the wireless device and the network side after the time gap, whether access to the network side is necessary.

10. The wireless device of claim 9, wherein the information about communication status includes at least one of Downlink timing change condition or Uplink synchronization status.

11. The wireless device of claim 1, wherein when Uplink synchronization status indicates the wireless device is out of Uplink synchronization, access to the network side is necessary, or
wherein when the Downlink timing change is larger than or equal to a threshold, the access to the network side is necessary.

12. A network device, comprising:
at least one antenna;
at least one radio coupled to the at least one antenna; and
a processor coupled to the at least one radio;
wherein the processor is configured to:
acquire gap configuration information indicating a time gap in which communication between a wireless device and the network device is allowed to stop; and
provide the gap configuration information to the wireless device.

13. The network device of claim 12, wherein the processor is further configured to determine the time gap based on change situation of the network device.

14. The network device of claim 12, wherein the processor is further configured to:
provide trigger information to the wireless device, so that the wireless device starts to stop the communication upon receipt of such trigger information.

15. The network device of claim 12, wherein the processor is further configured to:
provide, to the wireless device, an access indication information which indicates whether an access operation to a new network device shall be performed by the wireless device after the time gap.

16. A baseband processor configured to cause a wireless device to:
acquire gap configuration information;
stop communication between the wireless device and network side in a time gap indicated by the gap configuration information; and
resume the communication between the wireless device and the network side after the time gap.

17-22. (canceled)

23. The baseband processor of claim 16, wherein the gap configuration information includes a start time and an end time of the time gap, or the start time and a duration of the time gap.

24. The baseband processor of claim 16, wherein the time gap indicated in the gap configuration information depends on network device change situation.

25. The baseband processor of claim 16, further configured to feedback acknowledge information to the network side in response to receipt of the gap configuration information.

26. The baseband processor of claim 16, further configured to:
acquire trigger information; and
start to stop the communication in the time gap upon receipt of the trigger information.
